(19) United States
(12) Patent Application Publication
(10) Pub. No.: US 2003/0085479 A1
(43) Pub. Date: May 8, 2003

(54) Method for manufacturing disc-shaped substrate material

(76) Inventors: Mamoru Usami, Tokyo (JP); Yuuichi Kawaguchi, Tokyo (JP); Kenji Yamaga, Tokyo (JP); Yoshimi Sakai, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/288,477

(22) Filed: Nov. 6, 2002

(30) Foreign Application Priority Data
Nov. 7, 2001 (JP) 2001-342502

(51) Int. Cl. B29D 11/00

(52) U.S. Cl. 264/1.33

(57) ABSTRACT

A method for manufacturing a disc-shaped substrate material for an optical disc with a center hole is provided so as to form a resin layer with a uniform thickness distribution in a simple process. A stamper 10 is held to a movable metal mold 34 by suction means 36 in a cavity 31 in a mold assembly 30. The stamper 10 includes a through hole 10A with a diameter smaller than that of a center hole of an optical disc. When a disc-shaped substrate material 12 formed by injection molding is solidified, and the movable metal mold 34 is separated from a fixed metal mold 32, release means 38 is protruded from the through hole 10A so as to push the disc-shaped substrate material 12 for release.

### BACKGROUND OF THE INVENTION

1. Field of the Invention

The present invention relates to a method for manufacturing a disc-shaped substrate material to be manufactured into an optical disc.

2. Discussion of the Background

Generally, a disc-shaped optical recording medium (an optical disc) such as a CD (Compact Disc) and a DVD (Digital Versatile Disc) is manufactured by the following process. First, a stamper formed by a mastering process is attached in a metal mold mounted in an injection molding apparatus, and a disc-shaped substrate material is formed by injection-molding a resin within an area serving as an information recording surface. Then, a recording layer for reading information, and a reflective layer for use in reproducing information are formed on the obtained disc-shaped substrate material. Thereafter, a resin protective layer is provided on top of them, thereby completing the optical recording medium.

Information is recorded and/or read by rotating the disc while predetermined laser beam is irradiated onto the disc-shaped substrate material.

Conventionally, the optical disc is manufactured such that the stamper is attached in a cavity of the metal mold, and recesses and protrusions on the surface of the stamper are transferred to the surface of the disc-shaped substrate material so as to form the area serving as the information recording surface during the injection molding of the substrate. Then, the reflective film and the recording layer constituted for recording information are formed, and the resin protective layer is formed in the next process by, for example, spin coating methods so as to complete it as a product.

A center hole (with a diameter of 15 mm in this case) is generally formed at the center of the CD and DVD so as to position these optical discs during recording and/or reproducing.

A through hole larger than the center hole of the optical disc is generally provided on the stamper to be mounted in the metal mold, and is used for positioning in the mold and for filling a molten material. This through hole has a diameter of 20 to 38 mm for the CD and the DVD.

On the other hand, an optical disc such as one disclosed in Japanese Patent Laid-open Publication No. Hei. 8-235638 has recently attracted attention. This type of an optical disc is manufactured such that a support layer (a protective layer), which does not need to transmit light, namely, does not need to optically have a certain thickness, is formed thick as a disc-shaped substrate material (a substrate) by injection molding, a reflective film for use in reading information, a recording layer for recording information, or the like is formed on an information recording surface side of the substrate. Then, a light transmission layer (a resin layer corresponding to the protective layer on the CD and the like described before) is formed with a transparent resin layer for transmitting laser beam for recording and reading information on the reflective film or the recording layer, resulting in the laminated layers.

In the conventional manufacturing method of the optical disc, a disc-shaped substrate material is formed with a circular center hole 2A opened at the center of the disc by detaching and removing a center part of a substrate 2 and a sprue runner 3 hardened in a gate for the injection molding in a metal mold assembly 1 as shown in FIG. 7 when a substrate is injection-molded. Then, after a reflective film and a recording layer for recording are formed, a resin protective layer and a light transmission layer made of light transmission resin are formed by, for example, spin coating methods so as to complete as a product.

The substrate 2 is formed within a cavity 6 formed between an upper fixed metal mold 4 and a lower movable metal mold 5, and a stamper 7 is held by the fixed metal mold 4 through a stamper holder 8 in the metal mold assembly 1. Reference numeral 9 denotes a sprue bush in FIG. 7, and molten resin is injected through the sprue bush 9 into the cavity 6.

Since the mold assembly 1 has a constitution described above, the diameter of the center hole 2A of the substrate 2 is almost equal to the maximum diameter of the sprue runner 3. On the other hand, since the inside diameter of a positioning hole 7A at the center of the stamper 7 almost coincides with the outside diameter of the stamper holder 8 existing outside the sprue bush 9, the inside diameter of the positioning hole 7A is fairly larger than the center hole 2A.

On the other hand, as one of characteristic manufacturing methods of the protective layer or the light transmission layer of the disc described above, a manufacturing method is disclosed in Japanese Patent Laid-Open Publication No. Hei. 10-249264. In the manufacturing method, a cover-shaped member for covering the center hole of the optical disc is provided, and a resin is spin-coated from the upper side of the cover-shaped member so as to extend and harden the resin across the optical disc, thereby forming a protective layer (a resin layer). Since it is easy to control the layer thickness of the resin layer almost uniform especially in the radial direction on the application surface in this method, this method is also applicable to an invention disclosed in Japanese Patent Laid-Open Publication No. 1996-235638 for forming a light transmission layer.

To apply the spin coating method to the formation of a resin layer, especially the light transmission layer (50 to 150 μm) thicker than the protective layer (5 to 10 μm) so as to form a more uniform resin layer, the lid-shaped member which closes the center hole of the disc-shaped substrate material is necessary.

The lid-shaped member should be clean in this manufacturing method. Thus, it is necessary to provide a process for cleaning the lid-shaped member once the lid-shaped member is used for the resin application if the lid-shaped member is repeatedly used. Otherwise, it is necessary to dispose the lid-shaped member, and to always use a new (clean) one.

When the center hole is closed with the lid-shaped member in the spin coating as described before, since the light transmission resin usually flows down from the lid-shaped member to the surface of the disc-shaped substrate material, a bubble in the resin layer and a streak on the surface of the resin layer caused by a step between the lid-shaped member and the surface of the disc-shaped substrate material tend to present, or the layer thickness (the film thickness) tends to become uneven.

Further when the stamper holder 8 holds the stamper 7 in the conventional mold assembly 1 shown in FIG. 7, there is the problem that the thickness of the substrate 2 becomes uneven at a part in contact with the stamper holder 8, and consequently, the yield of forming the resin layer decreases.

### SUMMARY OF THE INVENTION

The present invention relates to a manufacturing method devised based on a view point different from that in the prior art described above, and provides a method for manufacturing a disc substrate material which simplifies the process, can form a resin layer (light transmission layer) having a more uniform thickness distribution, and increases the yield of forming the resin layer compared with the conventional general resin layer forming method and the manufacturing method using the lid-shaped member.

As a result of a dedicated research, the present inventor solved the problems above in a way described below. In the injection molding process which is one of optical manufacturing processes, a disc-shaped substrate material is formed without forming a center hole at the center, and is taken out from a mold assembly. Then, the center hole is formed to complete an optical disc after a film forming process, a resin layer forming process, and the like. Simultaneously a center hole is not formed or a center hole smaller in diameter than the center hole of the final optical disc is formed in the neighborhood of the center of the stamper, and a surface on the side of the light transmission layer of the obtained disc-shaped substrate material is formed by the stamper taking into account of the shape of the stamper applied in the injection molding.

Namely, the following aspect of the present invention attains the object described above.

(1) A method for manufacturing a disc-shaped substrate material machined into an optical disc with a center hole at a center thereof, the optical disc including different types of function layers on a predetermined area of an information recording surface constituted so as to record and/or read information, the method comprising the step of: forming a disc-shaped substrate material into a shape without a hole at the center using a metal mold and a stamper placed in a cavity of the metal mold, said stamper having a through hole formed smaller in diameter than saidcenter hole in a neighborhood of the center.

(2) A method for manufacturing a disc-shaped substrate material to be formed into an optical disc without a center hole at a center thereof, the optical disc including different types of function layers on a predetermined area of an information recording surface constituted so as to record and/or read information, the method comprising the step of: forming a disc-shaped substrate material into a shape using a metal mold and a stamper placed in a cavity of the metal mold, said stamper having a through hole formed in a neighborhood of the center.

(3) The method for manufacturing a disc-shaped substrate material according to (1) or (2), wherein at least a part of a surface opposite to a transfer surface of said stamper is sucked to held the stamper to said metal mold.

(4) The method for manufacturing a disc-shaped substrate material according to any one of (1) through (3), wherein the inside diameter of the through hole on the stamper is set such that release means can pass therethrough, and said release means is protruded from said through hole to release the solidified disc-shaped substrate material after a molten material filled into the cavity of said metal mold is solidified.

(5) The method for manufacturing a disc-shaped substrate material according to any one of (1) through (3), wherein the inside diameter of the through hole on the stamper is set such that a molten material is filled therethrough, and said molten material is filled into the cavity of said mold through said through hole.

(6) The method for manufacturing a disc-shaped substrate material according to any one of (1) through (5), wherein the disc-shaped substrate material solidified in said cavity is released only by protruding said release means through said through hole.

(7) The method for manufacturing a disc-shaped substrate material according to any one of (1) through (6), wherein said mold is a hot runner type, and a molten material is filled into said cavity while the molten material is kept at a temperature higher than the solidifying temperature.

### BRIEF DESCRIPTION OF THE DRAWINGS

FIG. 1 is a schematic perspective view showing a method for manufacturing a disc-shaped substrate material and a method for manufacturing an optical disc from this material according to a first embodiment of the present invention;

FIG. 2 is a sectional view showing a mold assembly for use in this manufacturing method;

FIG. 3 is a sectional view showing a mold assembly in a manufacturing method according to a second embodiment of the present invention;

FIG. 4 is a sectional view showing a mold assembly in a manufacturing method according to a third embodiment of the present invention;

FIG. 5 is a sectional view showing a mold assembly in a manufacturing method according to a fourth embodiment of the present invention;

FIG. 6 is a sectional view showing a mold assembly using stamper suction means different from that in any one of the embodiments; and

FIG. 7 is a sectional view showing a mold assembly for use in a conventional method for manufacturing an optical disc.

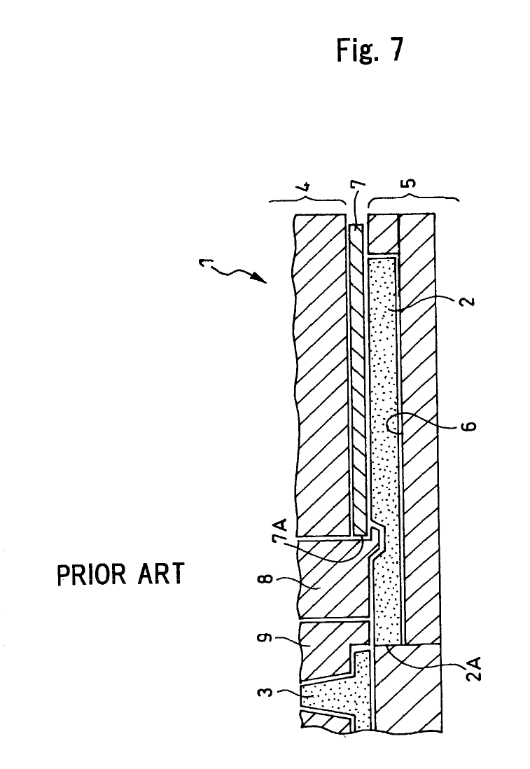

### DESCRIPTION OF THE EMBODIMENTS

The following section will describe embodiments of the present invention with reference to the accompanying drawings.

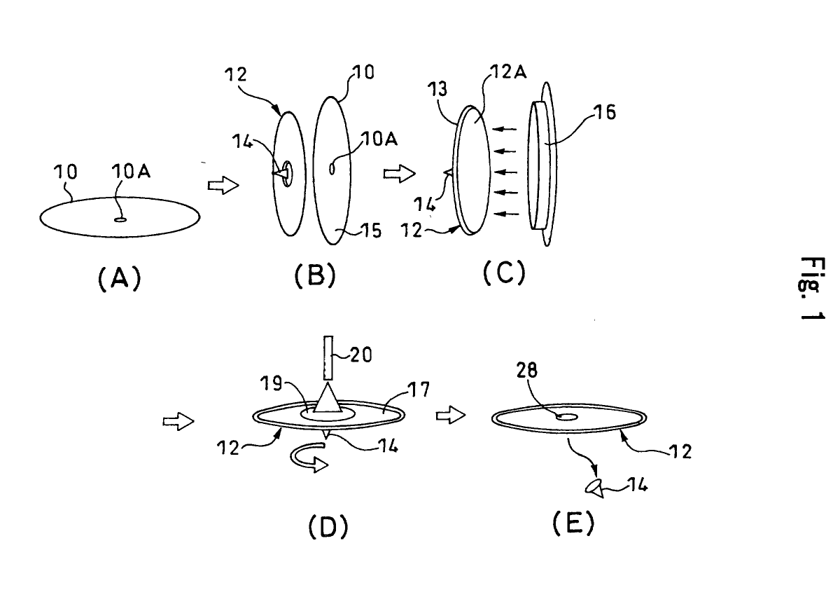

Referring to FIG. 1, a method for manufacturing a disc-shaped substrate material, and a method for manufacturing an optical disc from the same according to a first embodiment of the present invention. The optical disc obtained in the present embodiment has a center hole of 15 mm in diameter.

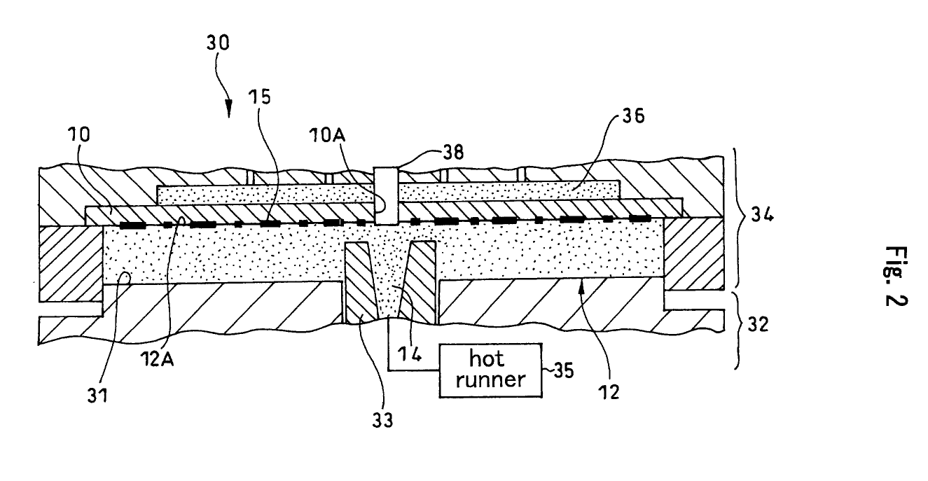

In this manufacturing method, first, a stamper 10 including a pattern for forming an information recording surface (see FIG. 1(A)) is set in a mold assembly 30 (see FIG. 2), and then, molten synthetic resin is injected into a cavity of this mold assembly 30 so as to form a disc-shaped substrate material 12.

In the injection molding, since a center part of the disc-shaped substrate material 12 is not removed, namely, a center hole is not formed, the disc-shaped substrate material 12 is took out from the mold assembly 30 while a sprue runner 14 is integrally attached (see FIG. 1(B)). Then, a center hole 28A including the sprue runner 14 is punched off finally after sputtering process (see FIG. 1(C)) and spin coating process (see FIG. 1(D)).

As shown in FIG. 2, the mold assembly 30 includes a fixed metal mold 32 and a movable metal mold 34. The stamper 10 has a through hole 10A with an inside diameter of 10 mm at the center, and is placed in the mold assembly 30 on the side of the movable metal mold 34, which is opposite to a gate 33 for filling the molten synthetic resin.

A hot runner 35 is provided upstream from the gate 33, and keeps the synthetic resin, which is in the molten state and is filled from the gate 33 into the mold cavity, at a temperature higher than the solidifying temperature.

As described above, the stamper 10 is placed on the side of the movable metal mold 34. Thus, suction means 36 is provided on the side of the movable metal mold 34. The suction means 36 is for applying a negative pressure to suck and fix the stamper 10 on the movable metal mold 34. This suction means 36 is made of continuous expanded metal from the rear side of which a negative pressure is applied, for example, sucks the stamper 10, and simultaneously maintains the stamper 10 as flat (as a mirror surface) against the pressure of the resin.

Also, release means 38 comprising an ejector pin, for example, is provided at a position corresponding to the through hole 10A at the center of the stamper 10. The release means 38 protrudes inside the cavity 31 of the molding apparatus 30 through the through hole 10A, and presses the disc-shaped substrate material 12 solidified after the injection molding so as to release the disc-shaped substrate material 12 from the movable metal mold 34 separated from the fixed metal mold 32.

The stamper 10 is constituted such that the through hole (inner peripheral end) 10A of the stamper 10 positions the stamper 10 in the radial direction with respect to the movable mold 34.

In the manufacturing method of the present embodiment, the synthetic resin in the molten state is injected into the cavity 31 from the gate 33 after the synthetic resin has passed through the hot runner 35.

After the disc-shaped substrate material 12 is solidified in the cavity 31, the movable metal mold 34 is separated from the fixed metal mold 32. At this time, the end of the separation means 38 is protruded through the through hole 10A toward the fixed metal mold 32 so as to release the solidified disc-shaped substrate material 12 from the movable metal mold 34.

Reference numeral 15 in FIG. 1 and FIG. 2 denotes a pattern on the stamper 10 for forming an area which is formed on the surface of the obtained disc-shaped substrate material 12 on the side of the movable mold 34, and serves as an information recording surface. This pattern 15 is provided corresponding to a format of the optical disc completed after the center hole 28 is formed.

A thin film 17 is formed with sputtering an inorganic material 16 on the information recording surface 12A of the disc-shaped substrate material 12 released from the mold assembly 30 as shown in FIG. 1(C), for example.

A resin material for forming a light transmission resin layer 19 is applied with a spin coating method, for example, on the disc-shaped substrate material 12 on which the thin film 17 has been formed with sputtering as shown in FIG. 1(D). In the present embodiment, ultraviolet curing resin is used. The resin is hardened by radiating ultraviolet ray after the application, then the desired center hole 28 is formed by blanking a part including the sprue runner 14 with an ultrasonic press or the like as shown in FIG. 1(E), and consequently, the optical disc is completed.

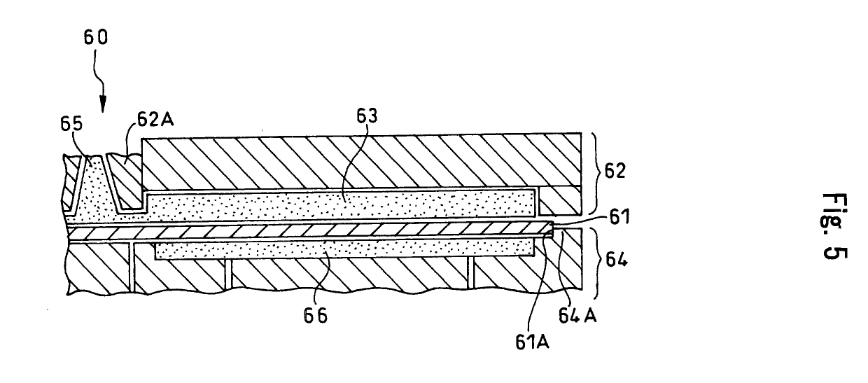

While the stamper exists on the movable side in the embodiment above, the stamper may exits on the fixed side as in a second embodiment. Also, the stamper may not have a through hole as shown in a fourth embodiment shown in FIG. 5.

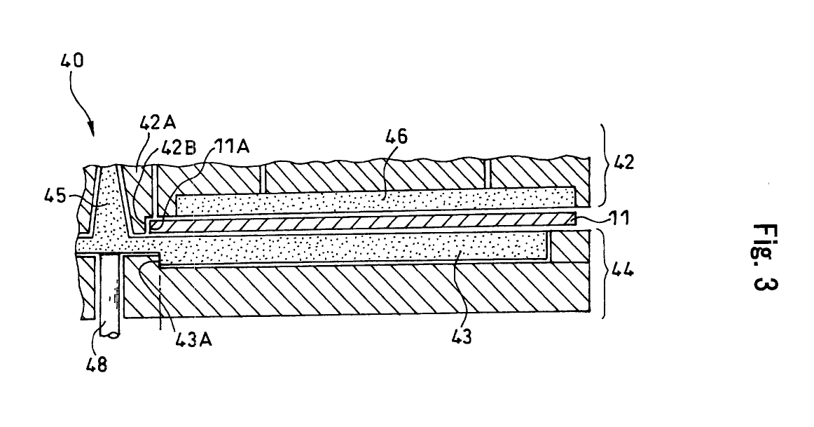

A fixed metal mold 42 is provided on the upper side, and a movable metal mold 44 is provided on the lower side in a molding apparatus 40 used in the second embodiment shown in FIG. 3, and a stamper 11 is sucked and held by suction means 46 as in the previous embodiment on the side of the fixed metal mold 42. Reference numerals 45 and 48 in FIG. 3 respectively denote a sprue runner and release means as in the previous example.

A through hole 11A of the stamper 11 is smaller in diameter than a center hole 43A of a disc-shaped substrate material 43, and simultaneously, a bottom end outer periphery step 42B of the sprue bush 42A in FIG. 3 positions the stamper 11 at the through hole 11A. This mold assembly 40 does not include a stamper holder.

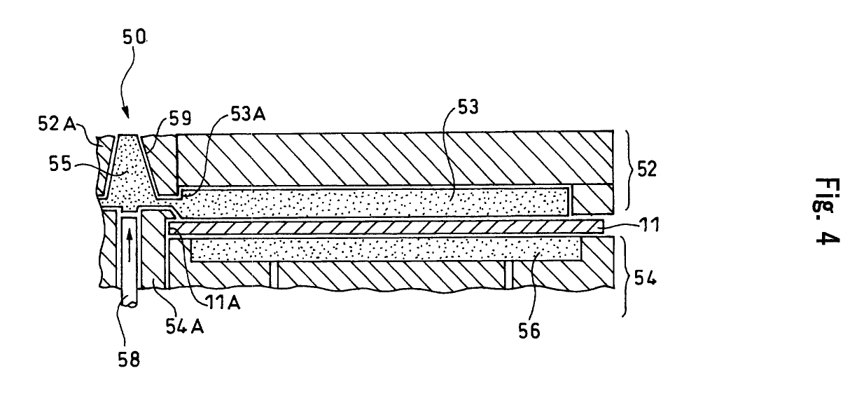

The following section describes a mold assembly 50 used in a third embodiment of the present invention shown in FIG. 4.

This mold assembly 50 is constituted such that a fixed metal mold 52 is provided on the upper side, and a movable metal mold 54 is provided on the lower side, and the stamper 11 is sucked and held by suction means 56 as in the previous examples on the side of the movable metal mold 54.

Also, release means 58 comprising a protruding pin is provided at the center of the movable metal mold 54 which opposes to a gate 59 on the side of the fixed metal mold 52 in the third embodiment.

In the third embodiment, the internal diameter of the through hole 11A of the stamper 11 is also smaller than the internal diameter of a center hole 53A of a disc-shaped substrate material 53. Reference numerals 52A, 54A, and 55 in FIG. 4 respectively denote a sprue bush, a stamper holder, and a sprue runner.

In this third embodiment, after the disc-shaped substrate material 53 is injection-molded, and molten resin is solidified, the disc-shaped substrate material 53 is released from the movable mold 54 by pushing upward the center of the disc-shaped substrate material 53 and the sprue runner 55 integrally formed therewith by release means 58 when the movable mold 54 is separated from the fixed mold 54.

The following section describes a mold assembly 60 used in a fourth embodiment of the present invention shown in FIG. 5.

This mold assembly 60 is constituted such that a fixed metal mold 62 is provided on the upper side, and a movable metal mold 64 is provided on the lower side. A stamper 61 does not include a through hole, and simultaneously, is sucked and held by suction means 66 as in the previous embodiment on the side of the movable metal mold 64.

A positioning protrusion 64A of the movable metal mold 64 positions an outer peripheral end 61B of the stamper 61 in the fourth embodiment. Reference numerals 62A and 65 in FIG. 5 respectively denote a sprue bush and a sprue runner.

In this fourth embodiment, after a disc-shaped substrate material 63 is injection-molded, and molten resin is solidified, the disc-shaped substrate material 63 is released by blowing air from gaps between the individual molds when the movable mold 64 is being separated.

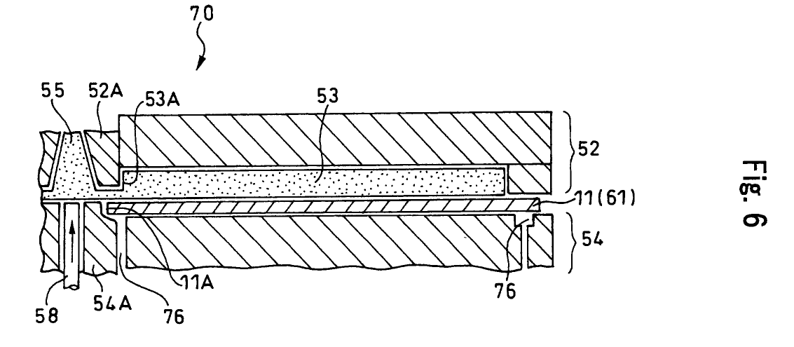

Although the continuous expanded metal to which a negative pressure is applied is used as the suction means 36, 46, 56, and 66 for the stampers 10, 11, and 61, the present invention is not limited to this constitution. For example, the stamper 11 (10 or 61) may be sucked by suction means 76 comprising grooves and slits to which a negative pressure is applied. The suction means 76 is provided in the mold at positions corresponding to the inner periphery and/or the outer periphery of an area other than the information recording area of the stamper 11 (10 or 61) in a mold assembly 70 as shown in FIG. 6 (parts the same as those in FIG. 4 have the same reference numerals) similar to the mold assembly 50 in the second embodiment.

Since the present invention is constituted as described above, no step formed by mold parts exists on the disc-shaped substrate material to be formed, and additionally, the disc-shaped substrate material is formed without a center hole. Thus, a variation in the film thickness within the surface of the resin layer formed later is reduced, and simultaneously, the present invention is excellent in the productivity. Consequently, the present invention provides an excellent effect of increasing the yield.

1. A method for manufacturing a disc-shaped substrate material to be formed into an optical disc with a center hole at a center thereof, the optical disc including different types of function layers on a predetermined area of an information recording surface constituted so as to record and/or read information, the method comprising the step of:
forming a disc-shaped substrate material into a shape without a hole at the center using a metal mold and a stamper placed in a cavity of the metal mold, said stamper having a through hole formed smaller in diameter than saidcenter hole in a neighborhood of the center.

2. A method for manufacturing a disc-shaped substrate material to be formed-into an optical disc without a center hole at a center thereof, the optical disc including different types of function layers on a predetermined area of an information recording surface constituted so as to record and/or read information, the method comprising the step of:
forming a disc-shaped substrate material into a shape using a metal mold and a stamper placed in a cavity of the metal mold, said stamper having a through hole formed in a neighborhood of the center.

3. The method for manufacturing a disc-shaped substrate material according to claim 1, wherein at least a part of a surface opposite to a transfer surface of said stamper is sucked to held the stamper to said mold.

4. The method for manufacturing a disc-shaped substrate material according to claim 2, wherein at least a part of a surface opposite to a transfer surface of said stamper is sucked to held the stamper to said mold.

5. The method for manufacturing a disc-shaped substrate material according claim 1, wherein the inside diameter of the through hole on the stamper is set such that release means can pass therethrough, and said release means is protruded from said through hole to release the solidified disc-shaped substrate material after a molten material filled into the cavity of said mold is solidified.

6. The method for manufacturing a disc-shaped substrate material according to claim 2, wherein the inside diameter of the through hole on the stamper is set such that release means can pass therethrough, and said release means is protruded from said through hole to release the solidified disc-shaped substrate material after a molten material filled into the cavity of said metal mold is solidified.

7. The method for manufacturing a disc-shaped substrate material according claim 3, wherein the inside diameter of the through hole on the stamper is set such that release means can pass therethrough, and said release means is protruded from said through hole to release the solidified disc-shaped substrate material after a molten material filled into the cavity of said metal mold is solidified.

8. The method for manufacturing a disc-shaped substrate material according to claim 1, wherein the inside diameter of the through hole on the stamper is set such that a molten material is filled therethrough, and said molten material is filled into the cavity of said metal mold through said through hole.

9. The method for manufacturing a disc-shaped substrate material according to claim 2, wherein the inside diameter of the through hole on the stamper is set such that a molten material is filled therethrough, and said molten material is filled into the cavity of said metal mold through said through hole.

10. The method for manufacturing a disc-shaped substrate material according to claim 3, wherein the inside diameter of the through hole on the stamper is set such that a molten material is filled therethrough, and said molten material is filled into the cavity of said metal mold through said through hole.

11. The method for manufacturing a disc-shaped substrate material according to claim 1, wherein the disc-shaped substrate material solidified in said cavity is released only by protruding said release means through said through hole.

12. The method for manufacturing a disc-shaped substrate material according to claim 2, wherein the disc-shaped substrate material solidified in said cavity is released only by protruding said release means through said through hole.

13. The method for manufacturing a disc-shaped substrate material according to claim 3, wherein the disc-shaped substrate material solidified in said cavity is released only by protruding said release means through said through hole.

14. The method for manufacturing a disc-shaped substrate material according to claim 5, wherein the disc-shaped substrate material solidified in said cavity is released only by protruding said release means through said through hole.

15. The method for manufacturing a disc-shaped substrate material according to claim 8, wherein the disc-shaped substrate material solidified in said cavity is released only by protruding said release means through said through hole.

16. The method for manufacturing a disc-shaped substrate material according to claim 1, wherein said metal mold is a hot runner type, and a molten material is filled into said cavity while the molten material is kept at a temperature higher than the solidifying temperature.

17. The method for manufacturing a disc-shaped substrate material according to claim 2, wherein said metal mold is a hot runner type, and a molten material is filled into said cavity while the molten material is kept at a temperature higher than the solidifying temperature.

18. The method for manufacturing a disc-shaped substrate material according to claim 3, wherein said metal mold is a hot runner type, and a molten material is filled into said cavity while the molten material is kept at a temperature higher than the solidifying temperature.

19. The method for manufacturing a disc-shaped substrate material according to claim 5, wherein said metal mold is a hot runner type, and a molten material is filled into said cavity while the molten material is kept at a temperature higher than the solidifying temperature.

20. The method for manufacturing a disc-shaped substrate material according to claim 8, wherein said metal mold is a hot runner type, and a molten material is filled into said cavity while the molten material is kept at a temperature higher than the solidifying temperature.

21. The method for manufacturing a disc-shaped substrate material according to claim 11, wherein said metal mold is a hot runner type, and a molten material is filled into said cavity while the molten material is kept at a temperature higher than the solidifying temperature.
